(19) United States
(12) Patent Application Publication
(10) Pub. No.: US 2004/0041016 A1
(43) Pub. Date: Mar. 4, 2004

(54) Communication system

(76) Inventors: Jan Asplund, Hono (SE); Jonas Linden, Goteborg (SE); Tommy Eriksson, Goteborg (SE); Mattias Arvin, Goteborg (SE); Gustav Liden, Stockholm (SE); Ozen Durust, Goteborg (SE)

Correspondence Address: HARNESS, DICKEY & PIERCE, P.L.C., P.O. BOX 8910, RESTON, VA, 20195, US

(21) Appl. No.: 10/399,259

(22) PCT Filed: Oct. 23, 2001
(86) PCT No.: PCT/SE01/02317

(30) Foreign Application Priority Data
Oct. 25, 2000 (SE) 0003880-2

(51) Int. Cl. G06F 17/00; G06F 15/16

(52) U.S. Cl. 235/375; 709/217

(57) ABSTRACT

A communication system (1) for transferring dental clinical case-related information (21) between a plurality of terminals (3), the system (1) comprising a server (5), a communication network (7) and terminals (3), said communication network (7) being adapted to allow electronic connection between the server (5) and the terminals (3). In the system (1), the server (5) comprises at least one processor (9) for controlling the communication of case-related information (21) between the server (5) and at least one terminal (3), and a memory unit (11) for storing case-related information (21), said terminals (3) comprising processor means (13) and means for presenting case-related information (15). The system is characterised in that the case-related information (21) comprises a basic information type (23) and a supplementary information type (25), the contents of the supplementary information type (25) being adapted to be addable by the users via the server (5) or at least one terminal (3), and that the terminals (3) have means (17) for entering case-related information (21) of supplementary information type (25).

### FIELD OF THE INVENTION

The present invention relates to a communication system for transferring dental clinical case-related information.

### BACKGROUND ART

The increasing knowledge in the dental care sector, and the resulting specialisation within the sector, means higher expectations from the public on the dental care offered. A problem is that the knowledge needed to offer high-quality dental care in many cases is manifested in a plurality of people who often live in different places. Today's operators in the dental care sector can be divided into two categories. The first category, the generalists, includes for example dentists and dental hygienists. In a typical case, they are the ones who have the first client contact. The second category, the specialists, are specialised within their field so as to be available as a kind of body to which a proposed measure is referred for consideration in cases where this is appropriate.

U.S. Pat. No. 5,616,899 discloses a system for controlling the fabrication of, for example, dental bridges, crowns, dental prostheses and gum shields in a dental laboratory. The manufacture of such appliances is effected in a series of iterations, the first of the iterations occurring upon receipt of a prescription for fabricating the appliance. An example of another iteration is when the appliance is returned to the dental laboratory for additional processing, such as final adjustment. The invention described in the US patent also concerns tracking appliances to establish in which step of a planned process in the laboratory the appliance is to be found. An important aid in this respect is bar codes associated with the appliances and bar-code readers. With the system it is possible to collect process-related data associated with each iteration during fabrication of an appliance. This data can then be used to describe the history of the fabrication of an appliance.

### SUMMARY OF THE INVENTION

A first object of the inventive communication system for transferring dental clinical case-related information between a plurality of terminals is to offer patients quicker access to dental care by speeding up the handling of case-specific problem data. The use of the communication system thus allows a faster digital transfer of case-related information directly between different users, which leads to a faster handling of cases. Today, case-related information is often sent by mail, which means that a lot of time is wasted, both for patients and dental care suppliers.

A second object of the communication system according to the invention is to provide an opportunity to reduce the administration currently required to handle cases and case-related information.

A third object of the communication system according to the invention is to offer patients dental care of a higher quality, by providing a system that allows analyses of case-related information to be carried out by a plurality of persons by making it easier to collect views from more persons.

A fourth object of the communication system according to the invention is to reduce the risk of patients' case-related information getting lost in the mail or in other ways.

A fifth object of the communication system according to the invention is to provide improved documentation for the users who are specialists asked to express their opinion about a case.

A sixth object of the communication system according to the invention is to increase patients' security as regards case-related information. Within the scope of the system according to the invention, only a limited number of users are given access to case-related information.

A seventh object of the communication system according to the invention is to offer an opportunity for patients to reduce the need to travel to see a specialist by providing a communication system that allows remote diagnoses.

To achieve the above objects the communication system comprises a server, a communication network and terminals, said communication network being adapted to allow electronic connection between the server and the terminals. The server comprises at least one processor for controlling the communication of case-related information between the server and at least one terminal, and a memory unit for storing case-related information. The terminals further comprise processor means and means for presenting case-related information and means for entering case-related information of supplementary information type.

In the communication system according to the invention, case-related information consists of two types: a basic information type and a supplementary information type. The information of the basic information type refers to the basic data entered by a user, for example a dental clinical generalist such as a dentist, as case-related information. The content of the supplementary information type refers primarily to information added by another user, such as a dental clinical specialist. By allowing users to add information to the supplementary information type, it is possible to update a case to arrive at a final recommendation as to how a user should act in a given situation.

Case-related information refers to two types of information: basic information and supplementary information. An example of basic information is patient's data, such as name, personal code number and address, attending person, and a description of the nature of the problems associated with the patient. An example of supplementary information is information added to the case by another system user. Each user who is granted access to case-related information can make additions to this information type via the server or a terminal. To enable input of supplementary information, terminals of the communication system have means for entering case-related information of supplementary information type.

Examples of types of basic information and supplementary information are pictures, such as radiographs, digital images and text. Markings in pictures are also conceivable.

Examples of domains for describing the nature of problems associated with patients are orthodontics, implants, root filling, periodontoclasia and changes in the mucous membrane for diagnosing diseases.

Examples of users of the communication system are dentists, dental technicians, pedodontists, periodontists, orthodontists, oral surgeons, denturists, endodontists and physiologists.

According to an embodiment, the means for presenting case-related information is adapted to present case-related information in such manner that the content of the basic information type and the supplementary information type, respectively, is presented in distinguishable manner. This means that a user who reads case-related information will know who has added each piece of supplementary information.

According to a further embodiment, the server is adapted to sequentially communicate case-related information to a plurality of terminals. This means that, in a first step, case-related information can be communicated from a terminal to the server. The case-related information is then communicated to a terminal, where a user reads the case-related information and optionally adds any supplementary information. Thereafter, the last user sends the case-related information to yet another user via the server. In this way, supplementary information is compiled, which eventually reaches the user who first communicated the case-related information.

According to a further embodiment, the server is adapted to provide access to and communicate case-related information in parallel to a plurality of terminals. This means that the user who, in a first step, sends case-related information from a terminal to the server is the one who controls which other users are granted access to the case-related information. The other users are notified that case-related information is available on the server and they can then, when appropriate, open the case-related information and add supplementary information.

According to a further embodiment, the server comprises presentation means and input means to facilitate, for example, system monitoring. It is also possible to enter case-related information via the server.

According to a further embodiment, the terminals are provided with a memory unit for storing case-related information. This allows case-related information to be stored temporarily before it is communicated to the server.

According to a further embodiment, the information of the basic information type comprises the subtypes case attributes and analysis information. The information of the case attributes subtype may be alterable. The information of the analysis subtype is not alterable, but has a more static character.

According to a further embodiment, the terminals consist of personal computers, which increases the chances of the system according to the invention being well received on the market.

According to a further embodiment, the server consists of a personal computer.

According to a further embodiment, the communication network consists of the Internet, which increases the chances of the system being well received on the market.

According to a further embodiment, the case-related information is adapted to be communicated in encrypted form, the purpose being to increase system security.

### BRIEF DESCRIPTION OF THE DRAWINGS

The invention will now be described in more detail with reference to the accompanying schematic drawings.

FIG. 1 is a schematic representation of the communication system according to the invention.

FIG. 2 is a schematic representation of a structure for case-related information.

### DESCRIPTION OF EMBODIMENTS

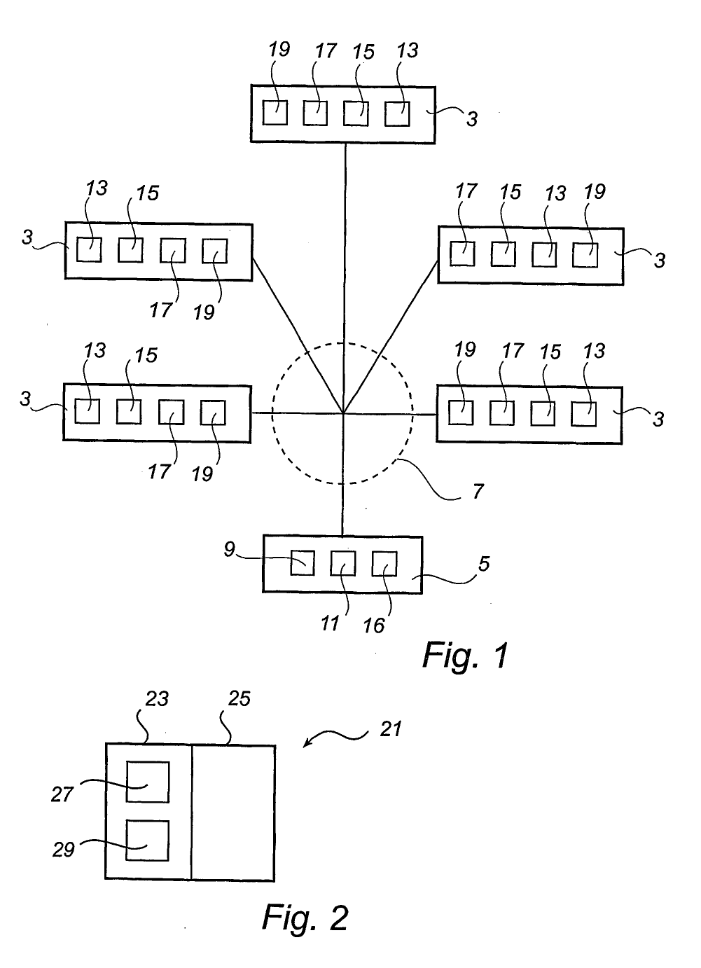

FIG. 1 shows a communication system for transferring dental clinical case-related information between a plurality of terminals 3. The system comprises a server 5, a communication network 7 and terminals 3. The communication network 7 is adapted to allow electronic communication between the server 5 and the terminals 3.

The server comprises at least one processor 9 for controlling the communication of case-related information between the server 5 and at least one of the terminals 3. The server 5 further comprises a memory unit 11 for storing case-related information. The terminals 3 comprise processor means 13 and means for presenting case-related information 15. In one embodiment, the server 5 comprises presentation means and input means 16. It should be noted that, instead of using only one server 5, it is possible to use a plurality of servers that are interconnected in an appropriate manner to achieve substantially the same function.

The fact that the means 15 for presenting case-related information at the terminals 3 may be adapted to present case-related information in such manner that the content of the basic information type and the supplementary information type, respectively, is presented in a distinguishable manner improves the possibility of drawing conclusions from the case-related information. An example of an issue is whether or not a tooth should be root-filled. The issue is formulated at a terminal 3 and communicated to the server 5 with a specific user as the intended recipient. The specific user, in this case a specialist, is notified, for example by e-mail, that the issue is available on the server 5. The specific user can then retrieve the case-related information and comment on it directly in a radiograph presented on the presentation means 15 of a terminal and indicate whether or not a root-filling is the appropriate action and, if so, provide further consultation as to how the root-filling should suitably be carried out.

In one embodiment, it is possible for a user to interact with the case-related information 21 via the terminal 3 by inserting text in connection with a picture, part of a picture, or an area in a picture.

In a further embodiment, it is possible to insert text in an existing picture and to indicate the location of a possible measure or indicate the location relative to which a user wants to obtain a recommendation/consultation. In a further embodiment, it is possible to indicate an area or a location by means of graphics, for example by a marking in the form of a line, a polygon or part of an arc of a circle. In this way, part of a tooth or a jaw may be marked, for example. Different users may here use different colours to distinguish their own comments from those of other users. It could also be a freehand mark. Accordingly, this means that, in this embodiment, the system also comprises a drawing tool for marking directly on or in pictures in order to make it easier for other users to take in the case-related information. In yet another embodiment, it is possible to temporarily hide some or all markings and legends in a picture depending on, for example, which user has entered the information.

This information is stored as supplementary information and communicated to the server 5. A condition is that the terminals 3 are provided with memory units 19 for storing case-related information.

It also appears from FIG. 1 that the terminals 3 are provided with means 17 for entering case-related information of supplementary information type 25. The user formulating the question is then notified that case-related information is available. It is also possible for the case-related information to be available simultaneously to a plurality of other users. This gives the invention a parallel quality, since a plurality of users can work on the same case-related information 21 more or less at the same time.

With reference to FIG. 2, a schematic representation of a structure for case-related information is shown. Case-related information 21, i.e. information associated with a case, comprises a basic information type 23 and a supplementary information type 25, the content of the supplementary information type 25 being adapted to be addable by users via one of the terminals 3. According to a further embodiment, the information of the basic information type comprises the subtypes case attributes 27 and analysis information 29. According to yet another embodiment, information of the case attributes subtype 27 may be alterable. This means that information regarding, for example, the patient's name and personal code number may be altered at a later stage. According to a further embodiment, information of the analysis subtype 29 is not alterable. An example of the content of the analysis subtype is the basic issue stored by a user as case-related information 21 before the case-related information 21 is communicated to the server 5.

The case-related information communicated by the server 5 can have a plurality of functions. At a first stage, the case-related information 21 may concern an inquiry, an opinion or a consultation. At a later stage, a therapy plan, in the form of supplementary information 25, may be formulated by an individual user of the communication system. Alternatively, a therapy plan may develop as a result of opinions from several users, i.e. case-related information 21 has been communicated between a number of different users via the server 5. At a further stage, patient measures are included in the case-related information 21. A follow-up of the patient is optionally included as a last point, i.e. the patient is examined and new supplementary information is added to the case-related information 21 so as to be communicated to the server 5 and received by selected users.

According to a further embodiment, the terminals 3 consist of personal computers. According to yet another embodiment, the server 5 consists of a personal computer. According to a further embodiment, the communication network 7 consists of the Internet. According to a further embodiment, case-related information 21 is adapted to be communicated in encrypted form.

It should be pointed out that a user can read case-related information from any terminal. In other words, the system is not dependent on a certain user always using a certain terminal.

1. A communication system (1) for transferring dental clinical case-related information (21) between a plurality of terminals (3), the system (1) comprising a server (5), a communication network (7) and terminals (3), said communication network (7) being adapted to allow electronic connection between the server (5) and the terminals (3), in which system (1)
the server (5) comprises at least one processor (9) for controlling the communication of case-related information (21) between the server (5) and at least one terminal (3), and a memory unit (11) for storing case-related information (21),
the terminals (3) comprise processor means (13) and means for presenting case-related information (15), characterised in that
the case-related information (21) comprises a basic information type (23) and a supplementary information type (25), the content of the supplementary information type (25) being adapted to be addable by users via the server (5) or at least one terminal (3), that
the server (5) is adapted to communicate case-related information (21) sequentially to a plurality of terminals (3), and
the terminals (3) are provided with means (17) for entering case-related information (21) of supplementary information type (25).

2. A communication system (1) according to claim 1, wherein the means (17) for presenting case-related information (21) is adapted to present case-related information (21) in such manner that the content of the basic information type (23) and the supplementary information type (25), respectively, is presented in a distinguishable manner.

3. A communication system (1) according to claim 1, wherein the server (5) is adapted to provide access to and communicate case-related information (21) in parallel to a plurality of terminals (3).

4. A communication system (1) according to claim 1, wherein the server (5) comprises presentation means and input means (16).

5. A communication system (1) according to claim 1, wherein the terminals (3) are provided with a memory unit (19) for storing case-related information (21).

6. A communication system (1) according to claim 1, wherein the information of the basic information type (23) comprises the subtypes case attributes (27) and analysis information (29).

7. A communication system (1) according to claim 6, wherein information of the case attributes type (27) is alterable.

8. A communication system (1) according to claim 7, wherein information of the analysis information type (27) is not alterable.

9. A communication system (1) according to claim 1, wherein the terminals (3) consist of personal computers.

10. A communication system (1) according to claim 1, wherein the server (5) consists of a personal computer.

11. A communication system (1) according to claim 1, wherein the communication network (7) consists of the Internet.

12. A communication system (1) according to claim 1, wherein case-related information (21) is adapted to be communicated in encrypted form.
